(19) United States
(12) Patent Application Publication
(10) Pub. No.: US 2023/0022725 A1
(43) Pub. Date: Jan. 26, 2023

(54) BURNER ASSEMBLY, GAS TURBINE COMBUSTOR, AND GAS TURBINE

(71) Applicant: MITSUBISHI HEAVY INDUSTRIES, LTD., Tokyo (JP)

(72) Inventors: Shinichi FUKUBA, Tokyo (JP); Kenji MIYAMOTO, Yokohama-shi, Kanagawa (JP); Keisuke MIURA, Tokyo (JP); Tomohiro ASAI, Tokyo (JP); Tomo KAWAKAMI, Yokohama-shi, Kanagawa (JP); Kenta TANIGUCHI, Yokohama-shi, Kanagawa (JP)

(21) Appl. No.: 17/953,564

(22) Filed: Sep. 27, 2022

Related U.S. Application Data
(63) Continuation of application No. PCT/JP2021/016131, filed on Apr. 21, 2021.

(30) Foreign Application Priority Data
Apr. 22, 2020 (JP) 2020-076141

(51) Int. Cl. F23R 3/28; F02C 7/22

(52) U.S. Cl. CPC F23R 3/286; F02C 7/22; F05D 2240/35

(57) ABSTRACT

A burner assembly includes a plurality of bumers for mixing fuel and air. Each of the plurality of burners includes: at least one fuel nozzle for injecting the fuel; and a mixing passage into which the fuel injected from the at least one fuel nozzle and the air are introduced. Each fuel nozzle includes a protruding portion protruding upstream of an inlet of the mixing passage in a flow direction of the air. Each fuel nozzle includes a fuel injection hole formed on a side surface of the protruding portion. At least a portion of a first air passage for flowing the air is formed inside the protruding portion. The first air passage includes: an inlet formed on a surface of the protruding portion on an upstream side of the fuel injection hole in the flow direction of the air; and an outlet formed on a side surface of the protruding portion or a passage wall of the mixing passage. At least a portion of the outlet is formed downstream of the fuel injection hole in the flow direction of the air.

### TECHNICAL FIELD

The present disclosure relates to a burner assembly, a gas turbine combustor, and a gas turbine.

The present application claims priority based on Japanese Patent Application No. 2020-076141 filed on Apr. 22, 2020, the entire content of which is incorporated herein by reference. The present application is a continuation application based on a PCT Patent Application No. PCT/JP2021/016131 whose priority is claimed on Japanese Patent Application No. 2020-076141. The content of the PCT Application is incorporated herein by reference.

### BACKGROUND ART

As a technique for achieving low NOx while maintaining flashback resistance for fuel with a high risk of flashback (e.g., hydrogen), a large number of independent short flames are formed by a burner assembly (cluster burner).

In this technique, by arranging multiple mixing passages for mixing fuel and air to reduce the scale of fuel mixing, high mixing performance can be achieved without actively using swirling flow for mixing fuel and air.

Patent Document 1 discloses a burner assembly for suppressing flashback while reducing NOx. Each burner of this burner assembly includes a fuel nozzle and a mixing passage into which fuel and air are introduced. The fuel nozzle includes a protruding portion which protrudes upstream of an inlet of the mixing passage in the air flow direction. Further, a fuel injection hole is formed on a side surface of the protruding portion. Fuel injected from the fuel injection hole enters the inlet of the mixing passage together with air, so that the fuel and the air are mixed.

Patent Document 1 describes that, by injecting the fuel from the protruding portion which protrudes upstream of the inlet of the mixing passage in the flow direction of the air, the fuel and the air are effectively mixed to suppress the variation of fuel concentration in the mixing passage and reduce NOx. Further, it describes that since the air enters upstream of the inlet of the mixing passage and downstream of the nozzle injection hole, the increase in concentration of fuel is suppressed in the vicinity of the passage wall downstream of the fuel injection hole, so that it is possible to suppress flashback.

### CITATION LIST

### Patent Literature

Patent Document 1: JP2019-168198A

### SUMMARY

### Problems to be Solved

The burner assembly described in Patent Document 1 has room for further improvement in terms of suppressing flashback.

In view of the above, an object of the present disclosure is to provide a bumer assembly and a gas turbine combustor that can suppress flashback.

### Solution to the Problems

In order to achieve the above object, a bumer assembly according to the present disclosure includes a plurality of burners for mixing fuel and air. Each of the plurality of burners includes: at least one fuel nozzle for injecting the fuel; and a mixing passage into which the fuel injected from the at least one fuel nozzle and the air are introduced. Each of the at least one fuel nozzle includes a protruding portion protruding upstream of an inlet of the mixing passage in a flow direction of the air, and each of the at least one fuel nozzle includes at least one fuel injection hole formed on a side surface of the protruding portion. At least a portion of a first air passage for flowing the air is formed inside the protruding portion. The first air passage includes: an inlet formed on a surface of the protruding portion on an upstream side of the fuel injection hole in the flow direction of the air; and an outlet formed on a side surface of the protruding portion or a passage wall of the mixing passage. At least a portion of the outlet is formed downstream of the fuel injection hole in the flow direction of the air.

### Advantageous Effects

The present disclosure provides a burner assembly and a gas turbine combustor that can suppress flashback.

### BRIEF DESCRIPTION OF DRAWINGS

FIG. 1 is a schematic configuration diagram of a gas turbine 100 according to an embodiment of the present disclosure.

FIG. 2 is a cross-sectional view of the vicinity of a combustor 4.

FIG. 3 is a schematic partial perspective view of a portion of a burner assembly 32 according to an embodiment.

FIG. 4 is a schematic diagram of a portion of the burner assembly 32 when viewed from upstream in the air flow direction along the axis L (example of view A in FIG. 2).

FIG. 5 is a schematic diagram partially showing a configuration example of cross-section B-B in FIG. 4.

FIG. 6 is a schematic diagram showing the air flow and the fuel jet flow in the configuration shown in FIG. 4.

FIG. 7 is a schematic diagram of a portion of a cross-section of a burner assembly 032 according to a comparative embodiment.

FIG. 8 is a schematic perspective cross-sectional view partially showing a configuration example of cross-section C-C in FIG. 4.

FIG. 9 is a schematic perspective cross-sectional view of a portion of a burner assembly 032 according to a comparative embodiment.

FIG. 10 is a schematic perspective cross-sectional view showing the flow of fuel and air in the burner assembly 32 according to the above-described embodiment.

FIG. 11 is a schematic perspective cross-sectional view partially showing another configuration example of cross-section C-C in FIG. 4.

FIG. 12 is a diagram showing an example of the shape of an outlet 78 of an air passage 70 according to another embodiment.

FIG. 13 is a diagram showing an example of the shape of the air passage 70 according to another embodiment.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”. “centered”. “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered comers within the range in which the same effect can be achieved.

On the other hand, an expression such as “comprise”, “include”, “have”, “contain” and “constitute” are not intended to be exclusive of other components.

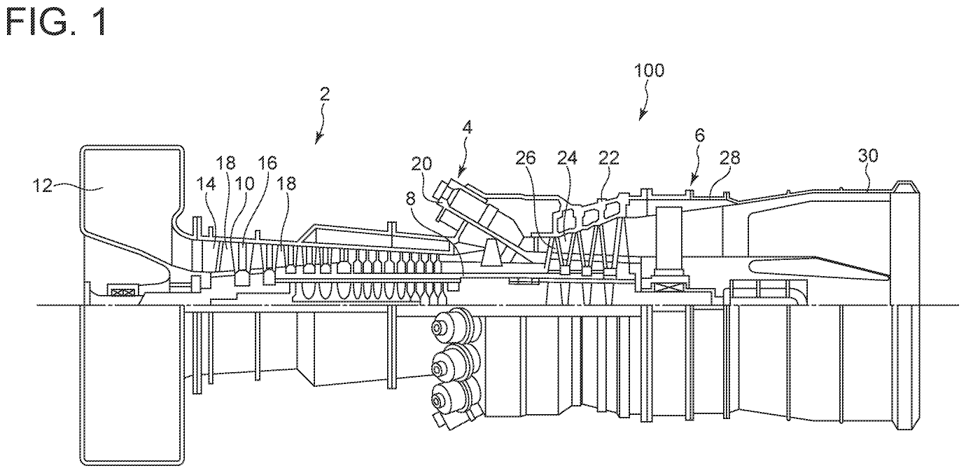

FIG. 1 is a schematic configuration diagram of a gas turbine 100 according to an embodiment of the present disclosure. As shown in FIG. 1, the gas turbine 100 according to an embodiment includes a compressor 2 for compressing air (i.e., producing compressed air) that serves as an oxidant supplied to a combustor 4, a combustor 4 (gas turbine combustor) for producing combustion gas using the compressed air and fuel, and a turbine 6 configured to be driven by the combustion gas discharged from the combustor 4. In the case of the gas turbine 100 for power generation, a generator (not shown) is connected to the turbine 6, so that rotational energy of the turbine 6 generates electric power.

In the combustor 4 of the gas turbine 100, a gas mixture of fuel and air is combusted to produce the combustion gas. Examples of the fuel combusted in the combustor 4 include hydrogen, methane, light oil, heavy oil, jet fuel, natural gas, and gasified coal, and one or more of them may be used in any combination for combustion.

The compressor 2 includes a compressor casing 10, an air inlet 12 disposed on an inlet side of the compressor casing 10 for sucking in air, a rotor 8 disposed so as to penetrate both of the compressor casing 10 and a turbine casing 22, and a variety of blades disposed in the compressor casing 10. The variety of blades includes an inlet guide vane 14 disposed adjacent to the air inlet 12, a plurality of stator vanes 16 fixed to the compressor casing 10, and a plurality of rotor blades 18 implanted on the rotor 8 so as to be arranged alternately with the stator vanes 16. In the compressor 2, the air sucked in from the air inlet 12 flows through the plurality of stator vanes 16 and the plurality of rotor blades 18 to be compressed into compressed air having a high temperature and a high pressure. The compressed air having a high temperature and a high pressure is sent to the combustor 4 of a latter stage from the compressor 2.

A plurality of combustors 4 are arranged at intervals in the circumferential direction around the rotor 8. The combustor 4 is supplied with fuel and the compressed air produced in the compressor 2, and combusts the fuel to produce combustion gas that serves as a working fluid of the turbine 6. The combustion gas is sent to the turbine 6 at a latter stage from the combustor 4.

The turbine 6 includes a turbine casing 22 and a variety of blades disposed in the turbine casing 22. The variety of blades includes a plurality of stator vanes 24 fixed to the turbine casing 22 and a plurality of rotor blades 26 implanted on the rotor 8 so as to be arranged alternately with the stator vanes 24. In the turbine 6, the rotor 8 is driven to rotate as the combustion gas passes through the plurality of stator vanes 24 and the plurality of rotor blades 26. In this way, the generator (not shown) connected to the rotor 8 is driven.

Further, an exhaust chamber 30 is connected to the downstream side of the turbine casing 22 via an exhaust casing 28. The combustion gas having driven the turbine 6 is discharged outside through the exhaust casing 28 and the exhaust chamber 30.

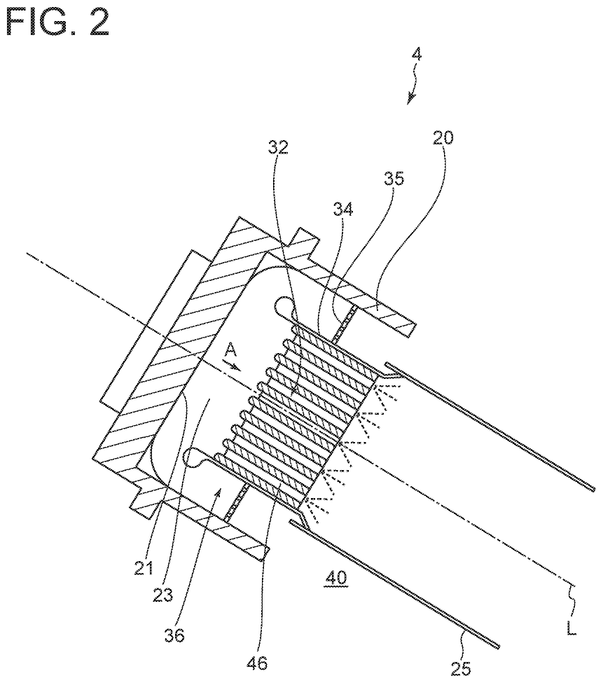

FIG. 2 is a cross-sectional view of the vicinity of the combustor 4. The combustor 4 includes a burner assembly 32, a bottomed cylindrical casing 20 for accommodating the bumer assembly 32, and a combustion liner 25 forming a space in which a flame is formed downstream of the burner assembly 32. In FIG. 2, the dash-dotted line indicates a central axis L common to the casing 20, the burner assembly 32, and the combustion liner 25. The bumer assembly 32 is disposed inside the casing 20 of the combustor 4.

In the illustrated exemplary embodiment, the bumer assembly 32 is held inside a cylindrical member 34 disposed inside the casing 20. The cylindrical member 34 is supported by the casing 20 via a plurality of support portions 35 arranged at intervals around the central axis L. An air passage 36 for the compressed air flowing from a casing 40 is formed between the casing 20 and the outer peripheral surface of the cylindrical member 34 (between the casing 20 and the outer peripheral surface of the burner assembly 32).

The compressed air flowing from the casing 40 into the air passage 36 passes through an axial gap 23 between the bumer assembly 32 and a bottom surface 21 of the casing 20 and enters a plurality of mixing passages 46, which will described later, of the burner assembly 32 together with fuel. The fuel and the air are mixed in the bumer assembly 32, and the mixture is ignited by an ignition device (not shown) to form a flame in the combustion liner 25 and produce the combustion gas.

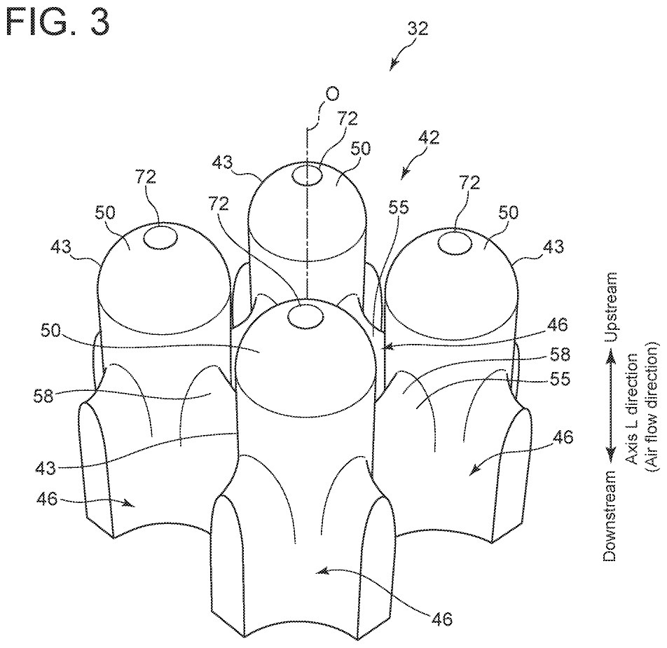

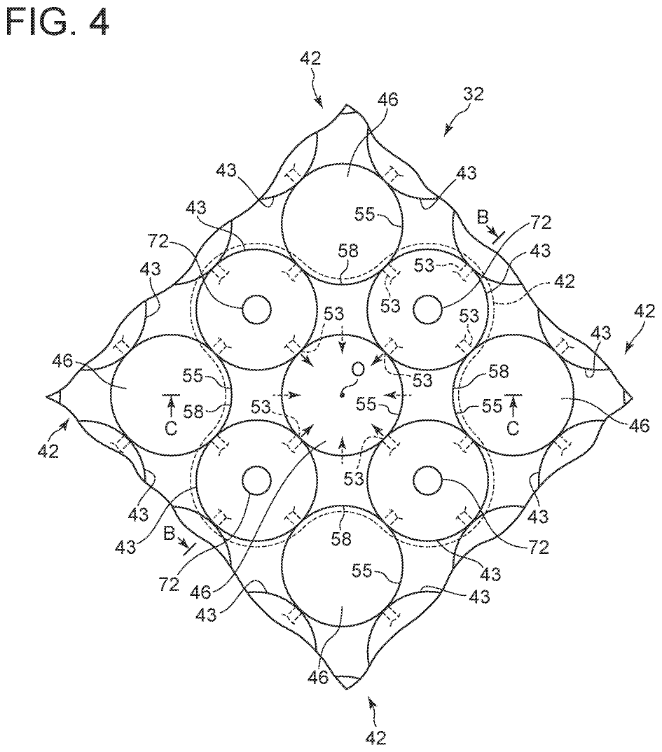

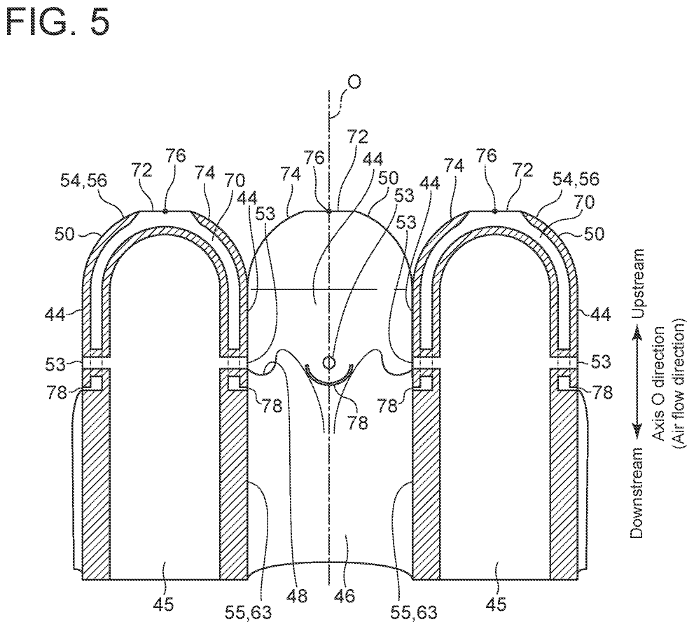

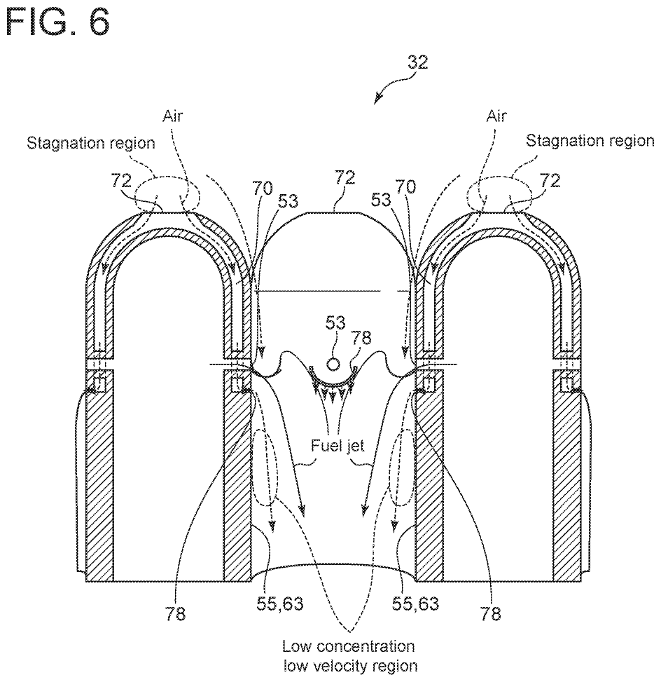

FIG. 3 is a schematic partial perspective view of a portion of a bumer assembly 32 (32A) according to an embodiment. FIG. 4 is a schematic diagram of a portion of the burner assembly 32 (32A) when viewed from upstream in the air flow direction along the axis L (example of view A in FIG. 2). FIG. 5 is a schematic diagram showing a portion of cross-section B-B in FIG. 4. FIG. 6 is a schematic diagram showing the air flow and the fuel jet flow in the configuration shown in FIG. 4.

For example, as shown in FIG. 3 or FIG. 4, the burner assembly 32 includes a plurality of burners 42 for mixing fuel and air.

Each burner 42 includes a plurality of fuel nozzles 43 for injecting the fuel, and a mixing passage 46 into which the fuel injected from the plurality of fuel nozzles 43 and the compressed air supplied from the casing 40 (see FIGS. 1 and 2) are introduced. In the illustrated exemplary embodiment, each burner 42 includes one mixing passage 46 and four fuel nozzles 43 arranged around the one mixing passage 46, and the fuel is injected from the four surrounding fuel nozzles 43 into the one mixing passage 46. In other words, four mixing passages 46 are arranged around one fuel nozzle 43, and the one fuel nozzle 43 injects the fuel into the four mixing passages 46.

Each mixing passage 46 is configured as a through hole extending in parallel with each other, and the central axis O of each mixing passage 46 extends in the direction along the central axis L of the casing 20. In the illustrated exemplary embodiment, the central axis O of each mixing passage 46 and the central axis L of the casing 20 are parallel to each other. Hereinafter, the direction along the central axis O of the mixing passage 46 (the longitudinal direction of the mixing passage 46) will be referred to as the axis O direction.

A passage wall 55 forming the mixing passage 46 is formed in a tubular shape so as to internally define the mixing passage 46 having a circular cross-section, and functions as a mixing tube for mixing fuel and air. In two mixing passages 46 closest to each other among the plurality of mixing passages 46, the respective passage walls 55 of the two mixing passages 46 share a partition portion 58 which separates the two mixing passages 46. In the exemplary embodiment shown in FIG. 4, the passage wall 55 of each mixing passage 46 shares the partition portion 58 with the passage walls 55 of multiple mixing passages 46 (four mixing passages 46 in the illustrated embodiment) surrounding it.

For example, as shown in FIG. 5, each fuel nozzle 43 includes a protruding portion 50 which protrudes upstream of an inlet 48 of the mixing passage 46 in the flow direction of the air. Further, each fuel nozzle 43 includes a fuel passage 45 formed inside the fuel nozzle 43 and a plurality of fuel injection holes 53 formed on a side surface 44 of the protruding portion 50. The fuel injection hole 53 injects the fuel supplied from the fuel passage 45 into the mixing passage 46. In the exemplary embodiment shown in FIG. 4, four fuel injection holes 53 are formed on the side surface 44 of the protruding portion 50 at positions corresponding to the four mixing passages 46 around the protruding portion 50.

For example, as shown in FIG. 5, a top surface 54 of the protruding portion 50 (the end surface of the protruding portion 50 in the direction of the axis O, i.e., the tip of the protruding portion 50) includes a convex curved surface 56. In the illustrated exemplary embodiment, the entire top surface 54 of the protruding portion 50 is composed of the convex curved surface 56 that is smoothly curved. The top surface 54 of the protruding portion 50 may be formed in a streamline shape, for example.

For example, as shown in FIG. 5, an air passage 70 for flowing the air is formed inside the protruding portion 50. The air passage 70 includes an inlet 72 formed on a surface 74 of the protruding portion 50 on the upstream side of the fuel injection hole 53 in the air flow direction. In the illustrated exemplary embodiment, the inlet 72 of the air passage 70 is formed at the apex 76 of the protruding portion 50.

Further, the air passage 70 includes an outlet 78 formed on the side surface 44 of the protruding portion 50 or a wall surface 63 of the passage wall 55 of the mixing passage 46 on the downstream side of the fuel injection hole 53 in the air flow direction. In the illustrated exemplary embodiment, the outlet 78 of the air passage 70 is formed in an arc shape around the fuel injection hole 53 on the downstream side of the fuel injection hole 53.

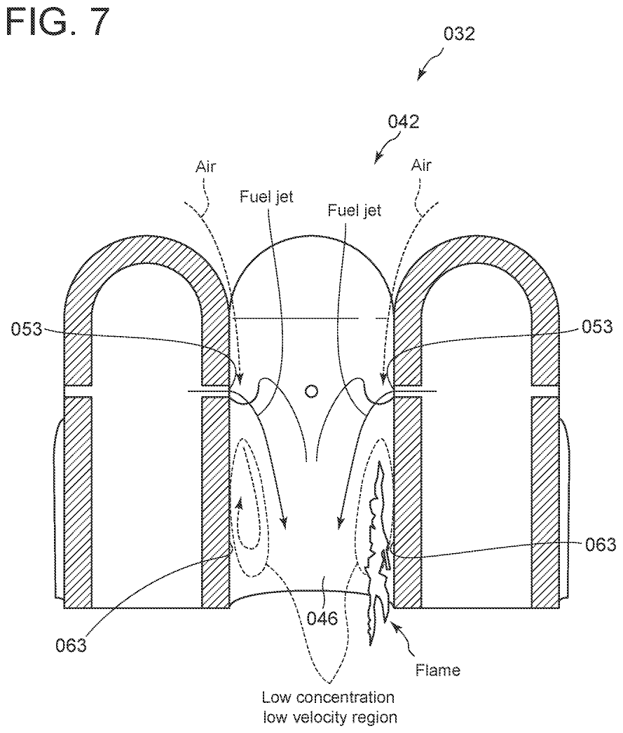

Here, the effect of providing the air passage 70 will be described in comparison with the comparative embodiment shown in FIG. 7 (the embodiment in which the air passage 70 is not provided).

In the comparative embodiment shown in FIG. 7, a region of low flow velocity and high fuel concentration is likely to be formed between the fuel jet injected from the fuel injection hole 053 and the wall surface 063 of the mixing passage 046. If some combustible source reaches this region due to flashback or the like, a flame may continue to be retained within the mixing passage 046, and burning damage may occur to the burner 042.

In contrast, as shown in FIG. 6, in the bumer assembly 32 in which the air passage 70 is provided, the air can be supplied between the passage wall 55 of the mixing passage 46 and the fuel jet injected from the fuel injection hole 53 through the outlet 78 at least partially formed downstream of the fuel injection hole 53. Then, the air supplied to the mixing passage 46 from the outlet 78 of the air passage 70 functions as film air that covers the passage wall 55 of the mixing passage 46, which reduces the fuel concentration in the vicinity of the passage wall 55. Thus, it is possible to suppress flashback and reduce the risk of flame holding in which a flame is held within the mixing passage 46, and suppress burning damage of the burner 42. Further, since the inlet 72 of the air passage 70 is formed on the top surface 54 of the protruding portion 50, the air can be effectively taken into the air passage 70 from the air stagnation region near the top surface 54 of the protruding portion 50.

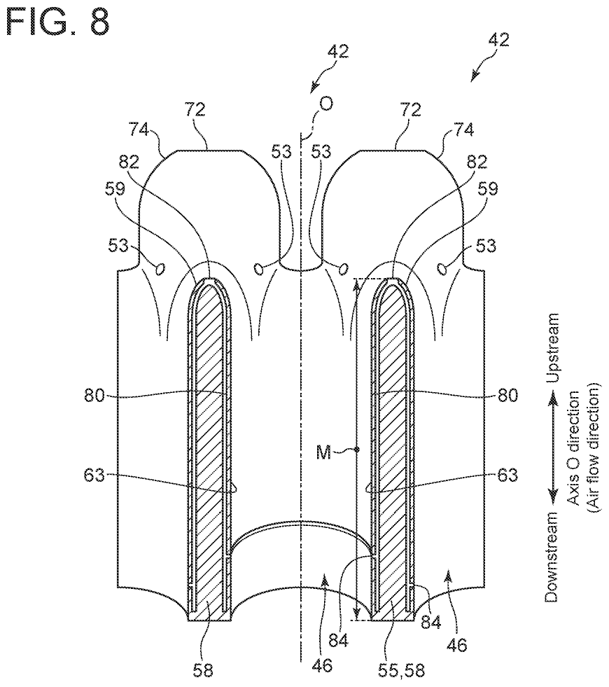

Next, an example of the configuration of the passage wall 55 of the mixing passage 46 will be described. FIG. 8 is a schematic perspective cross-sectional view partially showing a configuration example of cross-section C-C in FIG. 4.

As shown in FIG. 8, an air passage 80 for flowing the air is formed inside the passage wall 55. The air passage 80 includes an inlet 82 formed on an upstream end surface 59 of the passage wall 55 in the air flow direction. Further, the air passage 80 includes an outlet 84 formed on the wall surface 63 of the passage wall 55. In the illustrated exemplary embodiment, the outlet 84 of the air passage 80 is located downstream of the central position M of the mixing passage 46 in the direction along the central axis O of the mixing passage 46, and is annularly open around the central axis O on the wall surface 63 of the passage wall 55. The position of the outlet 84 may vary with the individual bumer 42.

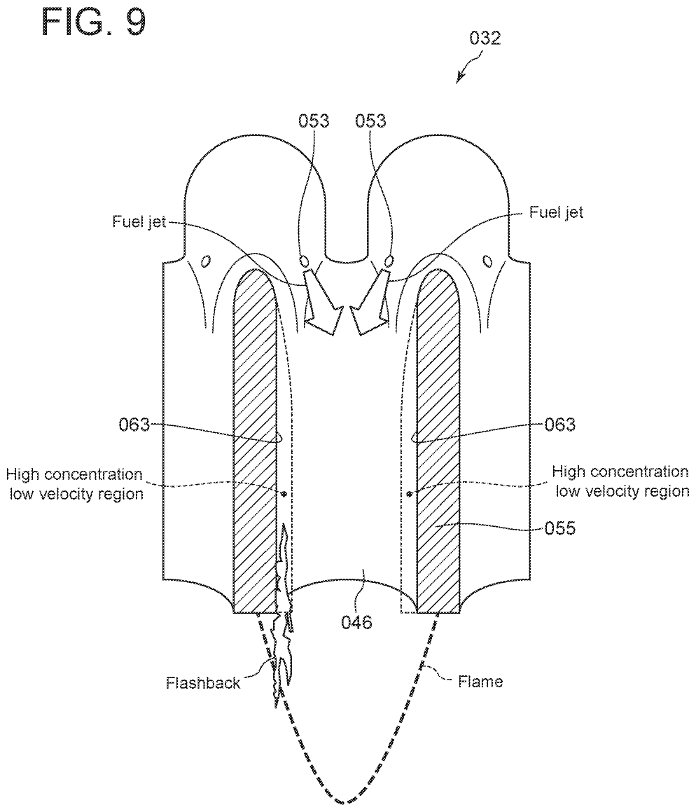

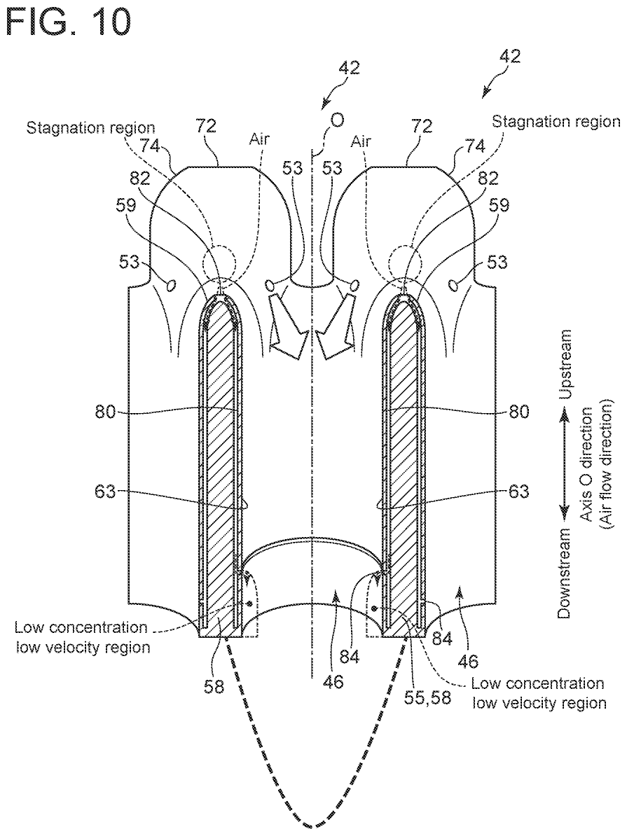

Here, the effect of providing the air passage 80 will be described in comparison with the comparative embodiment shown in FIG. 9 (the embodiment in which the air passage 80 is not provided). FIG. 9 is a schematic perspective cross-sectional view of a portion of a burner assembly 032 according to a comparative embodiment. FIG. 10 is a schematic perspective cross-sectional view showing the flow of fuel and air in the burner assembly 32 according to the above-described embodiment.

As shown in FIG. 9, the fuel injected from the fuel injection hole 053 is diffused downstream in the mixing passage 046, so if the distance for mixing fuel and air is long in order to reduce NOx, a region of high fuel concentration is likely to occur in the vicinity of the wall surface 063 of the mixing passage 046 on the downstream side of the fuel injection hole 053. Further, if the mixing passage 046 is long, a boundary laver easily develops on the wall surface 063, and a region of low flow velocity is likely to occur in the vicinity of the wall surface 063. When the region of high fuel concentration and low flow velocity is formed, flashback is likely to occur.

In contrast, as shown in FIG. 10, in the burner assembly 32, the air having passed through the air passage 80 inside the passage wall 55 of the mixing passage 46 is supplied to the mixing passage 46 through the outlet 84 which opens to the wall surface 63 of the passage wall 55. Accordingly, on the downstream side of the outlet 84 of the air passage 80, the fuel concentration in the vicinity of the wall surface 63 of the mixing passage 46 can be reduced. Thus, it is possible to reduce the risk of flashback, and suppress burning damage of the burner 42.

Further, since the outlet 84 of the air passage 80 is located downstream of the central position M (see FIG. 8) of the mixing passage 46 in the axis O direction of the mixing passage 46, the fuel concentration in the vicinity of the wall surface 63 can be reduced at the outlet side of the mixing passage 46, and the risk of flashback can be effectively reduced.

Further, since the inlet 82 of the air passage 80 is open to the upstream end surface 59 of the passage wall 55 in the air flow direction, the air in the stagnation region which tends to occur in the vicinity of the end surface 59 can be taken in to effectively reduce the risk of flashback.

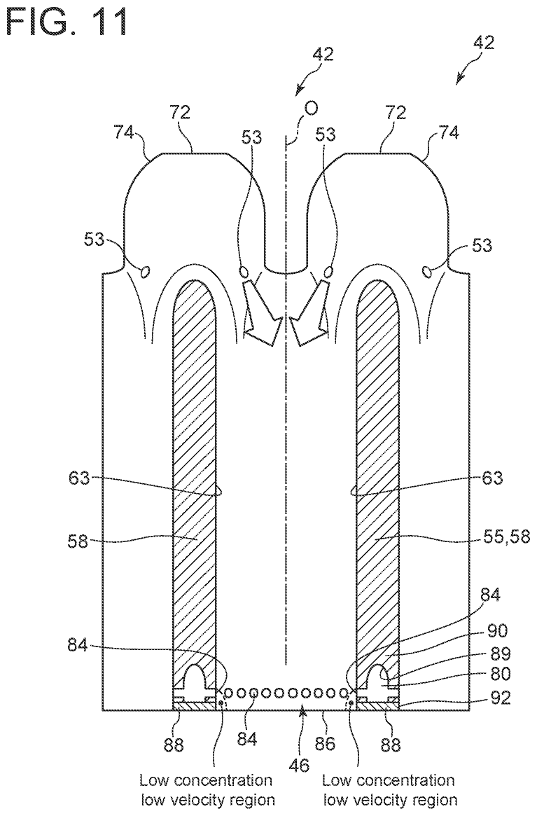

Next, another example of the configuration of the passage wall 55 of the mixing passage 46 will be described. FIG. 11 is a schematic perspective cross-sectional view partially showing another configuration example of cross-section C-C in FIG. 4.

In the embodiment shown in FIG. 11, similarly, an air passage 80 for flowing the air is formed inside the passage wall 55, but a specific configuration of the air passage 80 is different from the air passage 80 shown in FIG. 8, etc. The air passage 80 is supplied with cooling air for cooling the passage wall 55 of the mixing passage 46 from a cooling air supply source (not shown). Further, the outlet 84 of the air passage 80 is formed on the wall surface 63 of the passage wall 55 at an outlet portion 86 of the mixing passage 46, and the cooling air is supplied from the outlet 84 of the air passage 80 to the mixing passage 46.

In the exemplary embodiment shown in FIG. 11, the air passage 80 includes a grooved member 90 in which a groove 89 functioning as the air passage 80 is formed on one end surface 88, and a lid member 92 disposed so as to face the grooved member 90 and functioning as a lid for the groove 89. The lid member 92 has a plate shape.

Further, the air passage 80 has a plurality of outlets 84 formed on the wall surface 63 at the outlet portion 86 of the mixing passage 46. The outlets 84 are formed at intervals around the central axis O of the mixing passage 46.

In the configuration shown in FIG. 11, similarly, air having passed through the air passage 80 inside the passage wall 55 of the mixing passage 46 is supplied to the mixing passage 46 through the outlet 84 which opens to the wall surface 63 of the passage wall 55. Accordingly, on the downstream side of the outlet 84 of the air passage 80, the fuel concentration in the vicinity of the wall surface 63 of the mixing passage 46 can be reduced. Thus, it is possible to reduce the risk of flashback, and suppress burning damage of the burner 42. Further, by utilizing the cooling air for cooling the passage wall 55 of the mixing passage 46, the risk of flashback can be reduced while simplifying the configuration of the air passage 80. Further, when the grooved member 90 and the lid member 92 are separate members, a processing for forming the groove 89 of the grooved member 90 can be easily performed. The grooved member 90 and the lid member 92 may be integrally formed as a single component as a whole by a 3D printer, for example.

The present disclosure is not limited to the embodiments described above, but includes modifications to the embodiments described above, and embodiments composed of combinations of those embodiments.

For example, in the embodiments shown in FIG. 8, etc., the bumer assembly 32 in which the plurality of fuel nozzles 43 and the passage walls 55 forming the plurality of mixing passages 46 are integrally inseparably formed as a single component have been described. However, each fuel nozzle and each mixing passage may be separately formed as a single component, or the plurality of fuel nozzles and the plurality of mixing passages may be composed of any number of components.

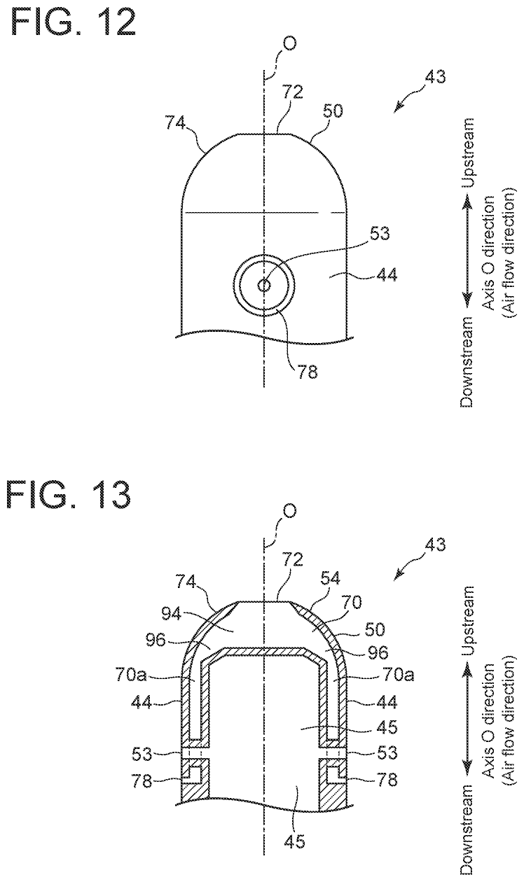

Further, in the configuration shown in FIG. 5, etc., the outlet 78 of the air passage 70 is formed downstream of the fuel injection hole 53, but as shown in FIG. 12, for example, the outlet 78 of the air passage 70 may be formed both downstream and upstream of the fuel injection hole 53. That is, at least a portion of the outlet 78 of the air passage 70 may be formed downstream of the fuel injection hole 53 in the air flow direction. With this configuration, the air can be supplied between the passage wall 55 of the mixing passage 46 and the fuel jet injected from the fuel injection hole 53. Then, the air supplied to the mixing passage 46 from the outlet 78 of the air passage 70 functions as film air that covers the passage wall 55 of the mixing passage 46, which reduces the fuel concentration in the vicinity of the passage wall 55. Thus, it is possible to reduce the risk that a flame is held within the mixing passage 46, and suppress burning damage of the bumer 42. The outlet 78 of the air passage 70 may be formed along a circle that goes around the fuel injection hole 53, for example, as shown in FIG. 12.

Further, for example, as shown in FIG. 13, a cavity 94 may be formed inside the protruding portion 50 of the fuel nozzle 43. The cavity 94 is configured as a part of the air passage 70 and has a larger flow-path cross-sectional area than that of a portion 70a of the air passage 70 downstream of the cavity 94 in the air flow direction. Further, the connection region between the cavity 94 and the portion 70a of the air passage 70 includes a reduction portion 96 where the flow-path cross-sectional area decreases downstream in the air flow direction. With this configuration, the air can be smoothly guided to the outlet 78 through the air passage 70 without excessively increasing the volume of the fuel passage 45 of the fuel nozzle 43.

Further, in the above-described embodiment, the air passage 70 has the outlet 78 in the vicinity of the fuel injection hole 53, but the air passage 70 may have the outlet 78 at the outlet side of the mixing passage 46. In this case, a part of the air passage 70 is formed inside the protruding portion 50, and the rest of the air passage 70 is formed inside the passage wall 55 of the mixing passage 46. Thus, the fuel concentration in the vicinity of the wall surface 63 can be reduced at the outlet side of the mixing passage 46, and the risk of flashback can be effectively reduced. That is, at least a portion of the air passage 70 may be formed inside the protruding portion 50.

Further, the inlet 82 of the air passage 80 may be provided on the surface of the protruding portion 50. In this case, a part of the air passage 80 is formed inside the passage wall 55 of the mixing passage 46, and the rest of the air passage 80 is formed inside the protruding portion 50.

The contents described in the above embodiments would be understood as follows, for instance.

(1) A bumer assembly (e.g., the above-described burner assembly 32) according to the present disclosure includes a plurality of bumers (e.g., the above-described burners 42) for mixing fuel and air. Each of the plurality of burners includes: at least one fuel nozzle (e.g., the above-described fuel nozzle 43) for injecting the fuel, and a mixing passage (e.g., the above-described mixing passage 46) into which the fuel injected from the at least one fuel nozzle and the air are introduced. Each of the at least one fuel nozzle includes a protruding portion (e.g., the above-described protruding portion 50) protruding upstream of an inlet (e.g., the above-described inlet 48) of the mixing passage in a flow direction of the air, and each of the at least one fuel nozzle includes at least one fuel injection hole (e.g., the above-described fuel injection hole 53) formed on a side surface (e.g., the above-described side surface 44) of the protruding portion. At least a portion of a first air passage (e.g., the above-described air passage 70) for flowing the air is formed inside the protruding portion. The first air passage includes: an inlet (e.g., the above-described inlet 72) formed on a surface of the protruding portion on an upstream side of the fuel injection hole in the flow direction of the air; and an outlet (e.g., the above-described outlet 78) formed on a side surface of the protruding portion or a passage wall (e.g., the above-described passage wall 55) of the mixing passage. At least a portion of the outlet is formed downstream of the fuel injection hole in the flow direction of the air.

With the burner assembly described in (1), the air can be taken into the first air passage through the inlet formed upstream of the fuel injection hole. Further, the air can be supplied between the passage wall of the mixing passage and the fuel jet injected from the fuel injection hole through the outlet at least partially formed downstream of the fuel injection hole. Then, the air supplied to the mixing passage from the outlet of the first air passage functions as film air that covers the passage wall of the mixing passage, which reduces the fuel concentration in the vicinity of the passage wall. Thus, it is possible to suppress flashback and reduce the risk of flame holding in which a flame is held within the mixing passage, and suppress burning damage of the bumers.

(2) In some embodiments, in the burner assembly described in (1), the inlet of the first air passage is formed on a top surface (e.g., the above-described top surface 54) of the protruding portion.

With the burner assembly described in (2), since the air can be effectively taken into the first air passage from the air stagnation region near the top surface of the protruding portion, the effect described in (1) can be improved.

(3) In some embodiments, in the bumer assembly described in (1) or (2), at least a portion of a second air passage (e.g., the above-described air passage 80) for flowing air is formed inside the passage wall of the mixing passage. The second air passage includes an outlet (e.g., the above-described 84) formed on a wall surface (e.g., the above-described wall surface 63) of the passage wall.

With the burner assembly described in (3), the air having passed through the second air passage inside the passage wall of the mixing passage is supplied to the mixing passage through the outlet which opens to the wall surface of the passage wall. Accordingly, on the downstream side of the outlet of the second air passage, the fuel concentration in the vicinity of the wall surface of the mixing passage can be reduced. Thus, it is possible to reduce the risk of flashback, and suppress burning damage of the bumers.

(4) In some embodiments, in the burner assembly described in (3), the outlet of the second air passage is located downstream of a central position (e.g., the above-described central position M) of the mixing passage in a longitudinal direction of the mixing passage.

With the burner assembly described in (4), the fuel concentration in the vicinity of the wall surface of the passage wall can be reduced at the outlet side of the mixing passage, and the risk of flashback can be effectively reduced.

(5) In some embodiments, in the bumer assembly described in (3) or (4), the second air passage includes an inlet formed on an upstream end surface (e.g., the above-described end surface 59) of the passage wall in the flow direction of the air.

With the burner assembly described in (5), the air in the stagnation region which tends to occur in the vicinity of the upstream end surface of the passage wall can be taken in to effectively reduce the risk of flashback.

(6) In some embodiments, in the burner assembly described in (3) or (4), the second air passage is supplied with cooling air for cooling the passage wall of the mixing passage. The outlet of the second air passage is formed on the wall surface of the passage wall at an outlet portion (e.g., the above-described outlet portion 86) of the mixing passage.

With the burner assembly described in (6), by utilizing the cooling air for cooling the passage wall of the mixing passage, the risk of flashback can be reduced while simplifying the configuration of the second air passage.

(7) A gas turbine combustor (e.g., the above-described combustor 4) according to the present disclosure includes: the burner assembly described in any one of (1) to (6); and a combustion liner (e.g., the above-described combustion liner 25) forming a space in which a flame is formed downstream of the bumer assembly.

With the gas turbine combustor described in (7), since the gas turbine combustor includes the burner assembly described in any one of (1) to (6), it is possible to reduce the risk of flashback and suppress burning damage of the burners. Consequently, it is possible to stably use the combustor.

(8) A gas turbine (e.g., the above-described gas turbine 100) according to the present disclosure includes: a compressor (e.g., the above-described compressor 2); a gas turbine combustor (e.g., the above-described combustor 4) configured to be supplied with air compressed by the compressor and fuel, and produce a combustion gas by combusting the fuel; and a turbine (e.g., the above-described turbine 6) driven by the combustion gas produced by the gas turbine combustor. The gas turbine combustor is the gas turbine combustor described in (7).

With the gas turbine described in (8), since the gas turbine includes the gas turbine combustor described in (7), it is possible to reduce the risk of flashback and suppress burning damage of the burners. Consequently, it is possible to stably operate the gas turbine.

### REFERENCE SIGNS LIST

2 Compressor
4 Combustor
6 Turbine
8 Rotor
10 Compressor casing
12, 48, 72, 82 Inlet
14 Inlet guide vane
16, 24 Stator vane
18, 26 Rotor blade
20 Casing
22 Turbine casing
25 Combustion liner
28 Exhaust casing
30 Exhaust chamber
32 Burner assembly
34 Cylindrical member
35 Support portion
36 Air passage
40 Casing
42 Burner
43 Fuel nozzle
44 Side surface
45 Fuel passage
46 Mixing passage
50 Protruding portion
53 Fuel injection hole
54 Top surface
55 Passage wall
56 Convex curved surface
58 Partition portion
59 End surface
63 Wall surface
70 Air passage (First air passage)
74 Surface
76 Apex
78 Outlet
80 Air passage (Second air passage)
84 Outlet
86 Outlet portion
88 On end surface
89 Groove
90 Grooved member
92 Lid member
100 Gas turbine

1. A burner assembly, comprising a plurality of bumers for mixing fuel and air,
wherein each of the plurality of bumers includes:
at least one fuel nozzle for injecting the fuel; and
a mixing passage into which the fuel injected from the at least one fuel nozzle and the air are introduced,
wherein each of the at least one fuel nozzle includes a protruding portion protruding upstream of an inlet of the mixing passage in a flow direction of the air,
wherein each of the at least one fuel nozzle includes at least one fuel injection hole formed on a side surface of the protruding portion,
wherein at least a portion of a first air passage for flowing the air is formed inside the protruding portion,
wherein the first air passage includes:
an inlet formed on a surface of the protruding portion on an upstream side of the fuel injection hole in the flow direction of the air; and
an outlet formed on a side surface of the protruding portion or a passage wall of the mixing passage, and
wherein at least a portion of the outlet is formed downstream of the fuel injection hole in the flow direction of the air.

2. The bumer assembly according to claim 1,
wherein the inlet of the first air passage is formed on a top surface of the protruding portion.

3. The burner assembly according to claim 1,
wherein at least a portion of a second air passage for flowing air is formed inside the passage wall of the mixing passage, and
wherein the second air passage includes an outlet formed on a wall surface of the passage wall.

4. The burner assembly according to claim 3,
wherein the outlet of the second air passage is located downstream of a central position of the mixing passage in a longitudinal direction of the mixing passage.

5. The burner assembly according to claim 3,
wherein the second air passage includes an inlet formed on an upstream end surface of the passage wall in the flow direction of the air.

6. The bumer assembly according to claim 3,
wherein the second air passage is supplied with cooling air for cooling the passage wall of the mixing passage, and
wherein the outlet of the second air passage is formed on the wall surface of the passage wall at an outlet portion of the mixing passage.

7. A gas turbine combustor, comprising:
the burner assembly according to claim 1; and
a combustion liner forming a space in which a flame is formed downstream of the bumer assembly.

8. A gas turbine, comprising:
a compressor;
a gas turbine combustor configured to be supplied with air compressed by the compressor and fuel, and produce a combustion gas by combusting the fuel; and
a turbine driven by the combustion gas produced by the gas turbine combustor,
wherein the gas turbine combustor is the gas turbine combustor according to claim 7.
